(19) United States
(12) Patent Application Publication
(10) Pub. No.: US 2010/0118532 A1
(43) Pub. Date: May 13, 2010

(54) ILLUMINATION DEVICE AND LIGHT EMITTING DIODE MODULE

(75) Inventors: Chia-Hao Liang, Taipei (TW); Chien-Chang Pei, Taipei (TW); Yi-Tsuo Wu, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: EVERLIGHT ELECTRONICS CO., LTD., Taipei (TW)

(21) Appl. No.: 12/615,253

(22) Filed: Nov. 9, 2009

(30) Foreign Application Priority Data
Nov. 10, 2008 (TW) 97143401

(51) Int. Cl. F21V 5/00; F21S 4/00

(52) U.S. Cl. 362/235; 362/249.02; 362/249.06

(57) ABSTRACT

A light emitting diode (LED) module including a carrier, a first connector, a plurality of second connectors and a plurality of LEDs is provided. The carrier has a first edge and a plurality of second edges. The first connector is disposed on the first edge of the carrier and electrically connected to the carrier. The second connectors are disposed on the second edges and electrically connected to the carrier respectively. Each of the second connectors may correspond and be electrically connected to the first connector of the other LED module. The LEDs are disposed on the carrier and electrically connected to the carrier.

### CROSS-REFERENCE TO RELATED APPLICATION

This application claims the priority benefit of Taiwan application serial no. 97143401, filed on Nov. 10, 2008. The entirety of the above-mentioned patent application is hereby incorporated by reference herein and made a part of specification.

### BACKGROUND OF THE INVENTION

1. Field of the Invention

The present invention relates to a light source module. More specifically, the present invention relates to a light emitting diode (LED) module.

2. Description of Related Art

A light emitting diode (LED) is a semiconductor device constituted mainly by a group III-V compound semiconductor material. The semiconductor material has a special property capable of converting the electrical energy into optical energy. More specifically, electrons and holes within the semiconductor material will combine to release the excessive energy in the form of light when a current is sent through the semiconductor material. Hence, the LED is able to emit light.

Because the light produced by the LED is a type of cold emission neither thermal emission nor electric discharge luminescence, the working life of an LED device often exceeds a hundred thousand hours. Furthermore, LED devices do not require idling time. In addition, the LED devices have a very high responsive speed (about 10⁻⁹ second), a very low degree of pollution (no mercury contained) and very high reliability. Moreover, they are of a very small volume, use very little electricity and are particularly suitable for mass production. With these advantages, the applications of light emitting diodes are far and wide.

Due to the characteristics of the LEDs of longer working life and little electricity consumption, fluorescent lamps and incandescent bulbs are gradually replaced with the LEDs in some fields, such as a scanning light source which requires high reaction speed, a backlight source of a liquid crystal display (LCD) device, car dashboard illumination for a car with front light source, traffic signs, large electronic display bulletins and general illumination devices.

Most of the conventional LED modules are arranged linearly, and the LED modules with the linear arrangement are usually suitable for application in strip-shaped lamps. When the linearly arranged LED modules are used in circular lamps or other shapes, plenty of blank regions would remain and consequently affect the overall appearance of the lamp. Moreover, since the conventional LED modules are applied in lamps, the entire lamp case needs to be detached when one of the elements in the LED module malfunctions and requires maintenance or replacement. As a result, the maintenance difficulty and the maintenance cost increase.

### SUMMARY OF THE INVENTION

The present invention provides a light emitting diode (LED) module. The LED module has a connector that can randomly connect a plurality of LED modules to form linear or planar illumination devices.

The present invention provides an LED module. The LED module includes a carrier, a first connector, a plurality of second connectors, and a plurality of LEDs disposed on the carrier. The carrier has a first edge and a plurality of second edges. The first connector is disposed on the first edge of the carrier and electrically connected to the carrier. The second connectors are disposed on the second edges of the carrier and electrically connected to the carrier respectively. Each of the second connectors may correspond and be electrically connected to the other LED module. The LEDs are electrically connected to the carrier.

In one embodiment of the present invention, a shape of the carrier includes a hexagon, and the LEDs are arranged to the hexagon.

In one embodiment of the present invention, the first connector has a plug portion protruding from the first edge. Each of the second connectors has a socket portion and the edges of the socket portions substantially align with the second edges.

In one embodiment of the present invention, further comprises a magnetic element. The magnetic element is disposed on the carrier so that the carrier has magnetism.

In one embodiment of the present invention, further includes a plurality of lenses. The lenses are disposed on the carrier, and cover the LEDs respectively.

In one embodiment of the present invention, the lenses are disposed on the carrier by adhering, screwing, or locking.

The present invention further provides an LED module. The LED module includes a carrier, a plurality of first connectors, a plurality of second connectors, and a plurality of LEDs disposed on the carrier. The carrier has a plurality of first edges and a plurality of second edges. The first connectors are disposed on the first edges of the carrier and electrically connected to the carrier respectively. The second connectors are disposed on the second edges of the carrier and are electrically connected to the carrier respectively. Each of the second connectors may be correspond and electrically connected to the first connectors of the other LED module. The LEDs are electrically connected to the carrier.

In one embodiment of the present invention, each of the first edges has a notch, and each of the first connectors has a plurality of first pins located within the notch and aligned with the first edge. Each of the second connectors has a plurality of second pins protruding from the second edge.

In one embodiment of the present invention, the second connectors and the first connectors are alternately arranged.

In one embodiment of the present invention, a shape of the carrier includes a hexagon, and the LEDs are arranged to the hexagon.

In one embodiment of the present invention, further includes a magnetic element. The magnetic element is disposed on the carrier so that the carrier has magnetism.

In one embodiment of the present invention, the LEDs are respectively located in the corners formed by each of adjacent two of the first edges and second edges.

In one embodiment of the present invention, further includes a plurality of lenses. The lenses are disposed on the carrier and cover the LEDs respectively.

The present invention further provides an LED module. The LED module includes a carrier, a plurality of LEDs, and at least a connecting wire. The LEDs and the connecting wire are disposed on the carrier and electrically connected to the carrier respectively.

In one embodiment of the present invention, a shape of the carrier includes a hexagon, and the LEDs are arranged to the hexagon.

In one embodiment of the present invention, further includes a magnetic element. The magnetic element is disposed on the carrier so that the carrier has magnetism.

In one embodiment of the present invention, further includes a plurality of lenses. The lenses are disposed on the carrier and cover the LEDs respectively.

The present invention further provides an illumination device. The illumination device includes a plurality of LED modules selected from the LED modules aforementioned. The LED modules are electrically connected to other LED modules by the first connector or the second connector of one LED module electrically connecting with the first connector or the second connector of the other LED module, or via the connecting wire.

In one embodiment of the present invention, further includes a magnetic element. The magnetic element is disposed on the carrier to provide the carrier with magnetism.

In one embodiment of the present invention, further includes a plurality of lenses. The lenses are disposed on the carrier and cover the LEDs respectively.

Based on the above, according to the present invention, since the LED module has the connector, a user can assemble the plurality of LED modules into a plurality of geometrical illumination devices via the plug portion of one of the connectors inserts to the socket portion of one of the connectors of the other LED module. Therefore, the present invention not only expands the application range of the LED modules, but also performs maintenance or replacement more conveniently.

In order to make the above and other features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic top view of an LED module in one embodiment of the present invention.

FIG. 1B is a cross-sectional view of the substrate depicted in FIG. 1A along a line I-I′.

FIG. 2A is a schematic top view of the combination of a plurality of LED modules in one embodiment of the present invention.

FIG. 2B is a schematic top view of the combination of a plurality of LED modules in another embodiment of the present invention.

FIG. 2C is a schematic top view of the combination of a plurality of LED modules in another embodiment of the present invention.

FIG. 2D is a schematic top view of the combination of a plurality of LED modules in another embodiment of the present invention.

FIG. 2E is a schematic top view of the combination of a plurality of LED modules in another embodiment of the present invention.

FIG. 2F is a schematic top view of the combination of a plurality of LED modules in another embodiment of the present invention.

FIG. 3 is a schematic top view of an LED module in another embodiment of the present invention.

FIG. 4 is a schematic top view of the combination of a plurality of LED modules in another embodiment of the present invention.

FIG. 5 is a schematic top view of an LED module in another embodiment of the present invention.

### DESCRIPTION OF EMBODIMENTS

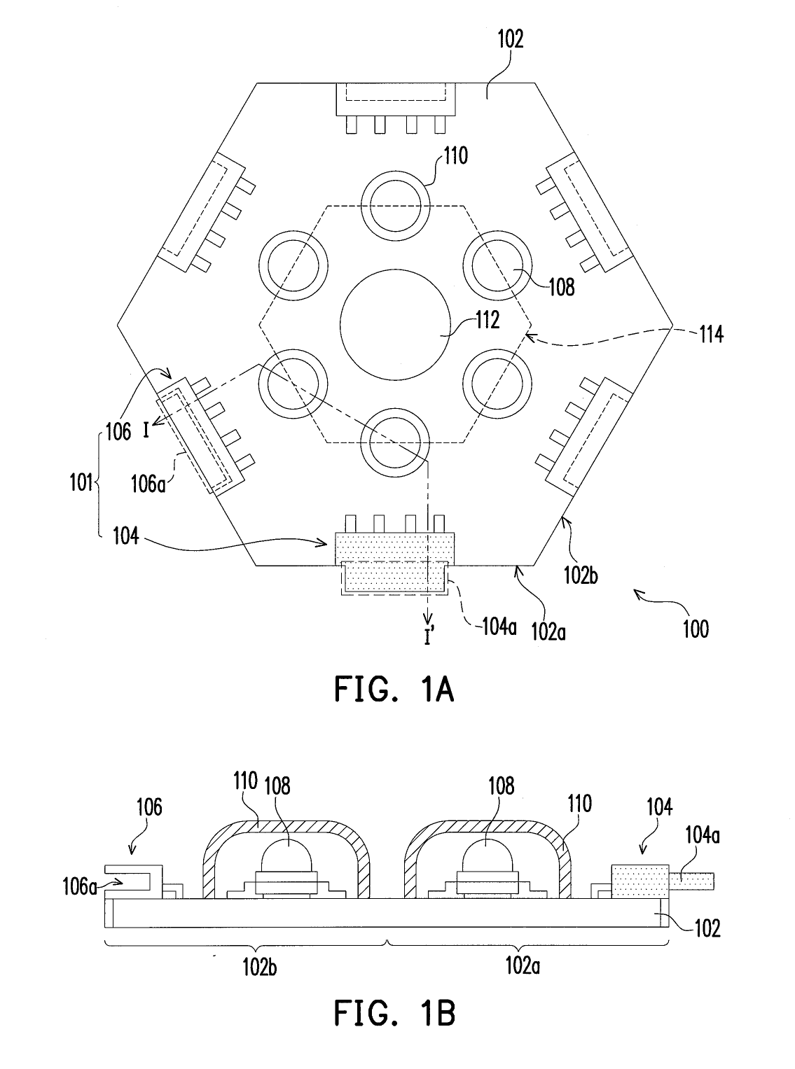

FIG. 1A is a schematic top view of an LED module in one embodiment of the present invention. FIG. 1B is a cross-sectional view of the substrate depicted in FIG. 1A along a line I-I′. Referring to FIGS. 1A and 1B, it should be noted that some components are omitted in FIG. 1A to simplify the description. In the present embodiment, an LED module 100 includes a carrier 102, a connector 101, a plurality of LEDs 108 and a plurality of lenses 110. Here, the connector 101 includes a first connector 104 and a plurality of second connectors 106 (in FIG. 1A, only five second connectors are exemplarily shown).

More specifically, the carrier 102 has a first edge 102a and a plurality of second edges 102b. Especially, in the present embodiment, the carrier 102 is a hexagonal structure, and the carrier 102 is a glass fiber (FR4) substrate or an aluminum substrate, for example. In other embodiments, the shape of the carrier 102 can be a quadrangle, a pentagon, or other polygons. Thus, the shape of the carrier 102 shown in FIG. 1A is merely exemplificative and should not be construed as limitations to the present invention.

The first connector 104 is disposed on the first edge 102a of the carrier 102 and electrically connected to the carrier 102. Herein, the first connector 104 includes a plug portion 104a, and the plug portion 104a protrudes from the first edge 102a. In other words, the first connector 104 is a male plug as a matter of fact.

The second connectors 106 are disposed on the second edges 102b of the carrier 102 respectively and electrically connected to the carrier 102. Each of the second connectors 106 includes a socket portion 106a, and the edges of the socket portions 106a substantially align with the second edges 102b. In other words, the second connectors 106 are female sockets as a matter of fact.

The LEDs 108 are disposed on the carrier 102 and electrically connected to the carrier 102. In the present embodiment, the LEDs 108 are the surface mount device (SMD) type LEDs. In addition, the LEDs 108 are arranged in equidistant arrangement along the track of the hexagon 114. Namely, the LEDs 108 are arranged to the hexagon. In other embodiments, the LEDs 108 can be arranged to a polygon or respectively disposed on a plurality of corners formed by the first edge 102a and the second edges 102b of the carrier 102. Therefore, the arrangement of the plurality of LEDs 108 indicated in FIG. 1A is merely exemplificative and should not be construed as limitations to the present invention.

Furthermore, the LEDs 108 include white light LEDs, red light LEDs, green light LEDs, or blue light LEDs. The LEDs 108 of different colors may constitute the LED modules 100 with different colors. For instance, a plurality of white light LEDs 108 constitutes a white light LED module 100. A plurality of red light LEDs 108 constitutes a red light LED modules 100. Thus, the user may assemble the LED modules 100 of different colors as required to produce diverse illumination effects.

It should be noted that the present invention is not limited to the number of the LEDs 108, the distance between the LEDs 108, the color combination and the arrangement methods. Despite six LEDs 108 are specified herein and arranged equidistantly along the track of a hexagon, the number of the LEDs 108, the distance between the LEDs 108, the color combination, and the arrangement methods can be properly modified in other embodiments by different users with various demands for brightness distribution, which still belongs to a technical means adoptable in the present invention and falls within the protection scope of the present invention.

Referring to FIG. 1B, the LED module 100 of the present invention includes the lenses 110 disposed on the carrier 102, and the lenses 110 cover the LEDs 108 respectively. In the present embodiment, the lenses 110 are disposed on the carrier 102 by adhering, screwing, or locking. In addition, the material of the lenses 110 includes glass or plastic. Especially, in the present embodiment, the material of the lenses 110 is transparent polymethyl methacrylate (PMMA). The light beam emitted by the LEDs 108 is transmitted to the external environment through the lenses 110. Therefore, not only the light emitting efficiency of the LEDs 108 is enhanced, but the light emitting uniformity of the LED module 100 is increased.

Moreover, in the present embodiment, the LED module 100 further includes a magnetic element 112. The magnetic element 112 is disposed on the carrier 102, wherein the magnetic element 112 is, for example, a magnet to provide the carrier 102 with magnetism. Namely, the carrier 102 has magnetism. The LEDs 108 can be magnetically attached to other magnetic devices through the magnetic device 112, so as to utilize the LED module 100 in an easy and convenient manner, and extend the application range of the LED module 100.

In the present embodiment, since the LED module 100 has the first connector 104 (i.e., the male plug) and the second connectors 106 (i.e., the female sockets), each of the second connectors 106 may correspond and be electrically connected to the first connector 104 of the other LED module 100. In other words, the user can assemble the plurality of LED modules 100 into a plurality of geometrical illumination devices via the plug portion 104a of the first connector 104 to the socket portion 106a of one of the second connectors 106 of the other LED module 100. A plurality of diverse illumination devices formed by the plurality of LED modules 100 in FIG. 1A is described in the following.

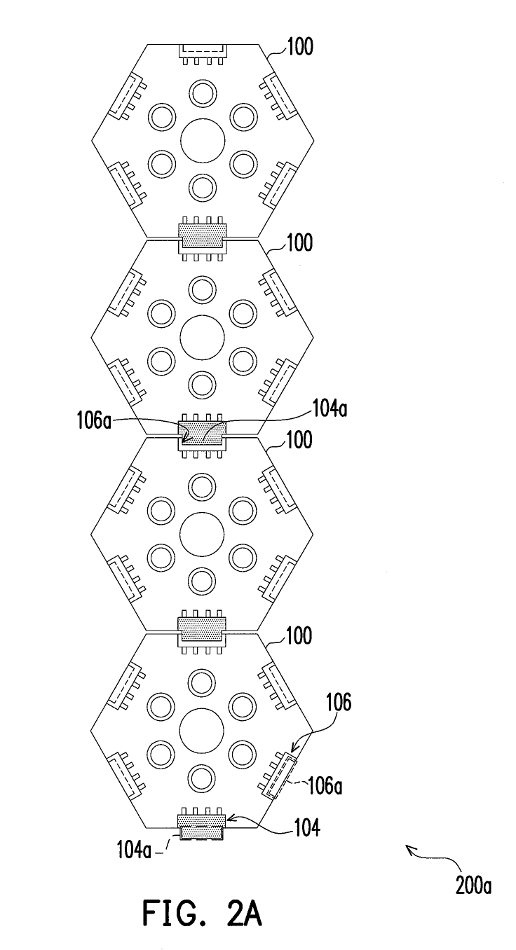

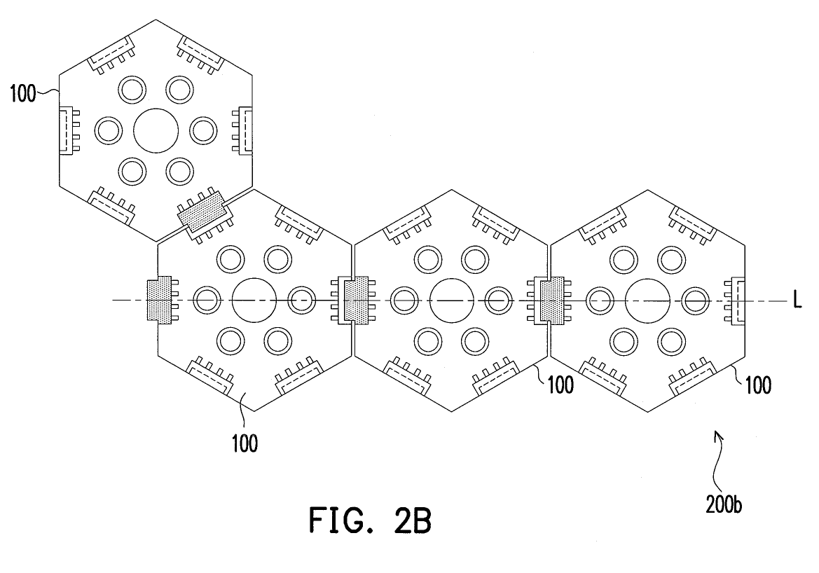

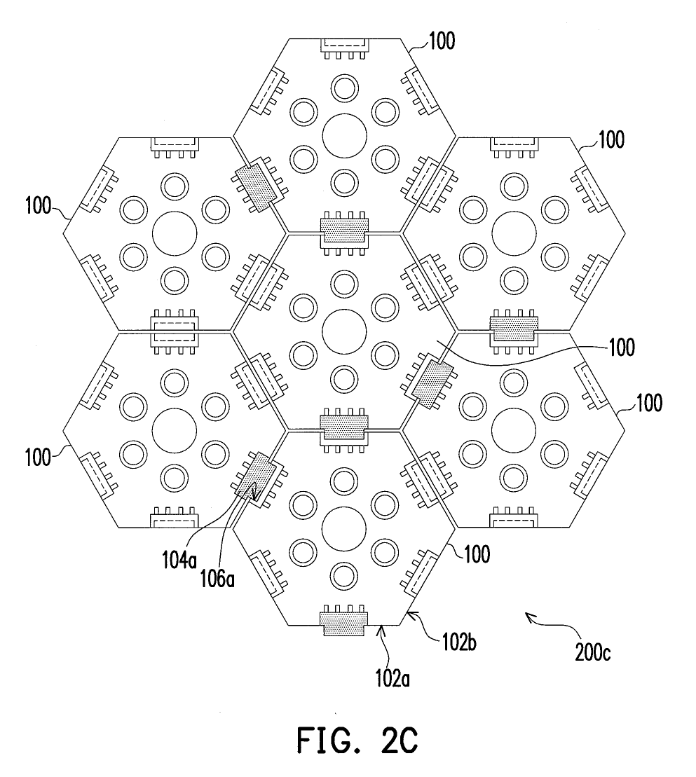

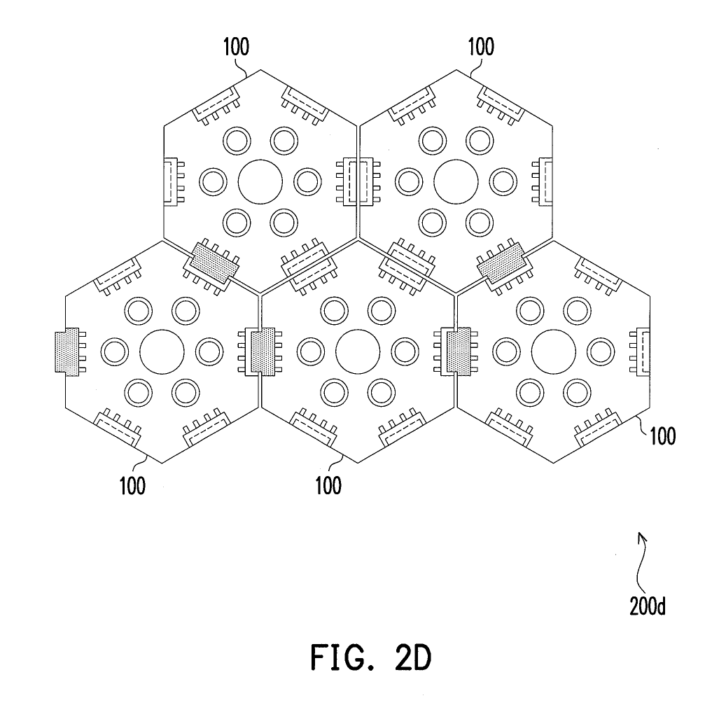

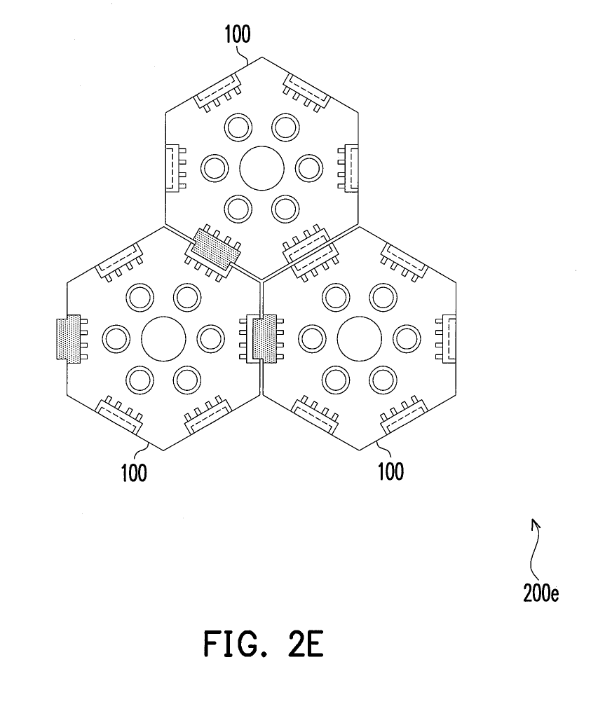

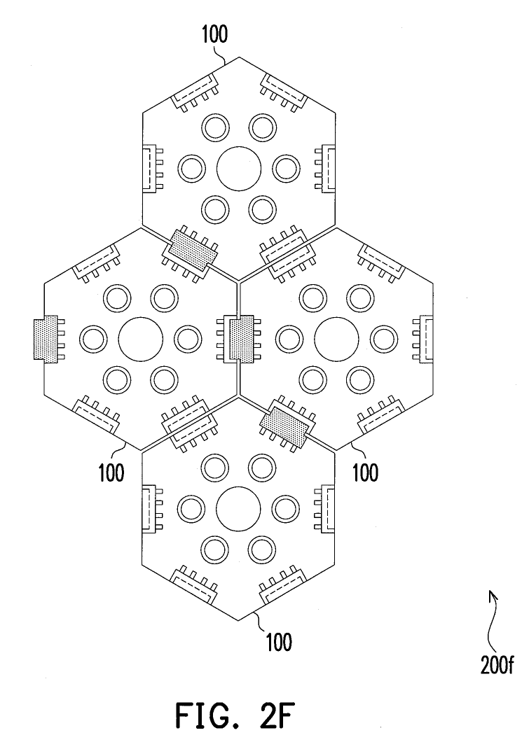

FIG. 2A is a schematic top view of the combination of a plurality of LED modules in one embodiment of the present invention. In the present embodiment, an illumination device 200a comprises with four LED modules 100 serial-connected together. In detail, the LED modules 100 are assembled into a straight structure, as the so called straight-type illumination device, via the plug portions 104a of the first connectors 104 connect to the socket portions 106a of the second connectors 106 of other LED modules 100. Moreover, in other embodiments, since all the LED modules 100 have hexagonal structures, in other words, each of the LED modules 100 has six edges, the plurality of LED modules 100 can be serially connected into a non-straight structure of an illumination device 200b. Namely, referring to FIG. 2B, at least one of the LED modules 100 is not arranged on a reference line L.

FIG. 2C is a schematic top view of the combination of a plurality of LED modules in another embodiment of the present invention. Referring to FIG. 2C, an illumination device 200c comprises with seven LED modules 100 serial-connected together or parallel-connected together. Specifically, in the present embodiment, a single LED module 100 is the center, and each edge of this LED module 100 (including the first edge 102a and the second edges 102b) is connected to the other LED module 100, and the LED modules 100 are all connected with each other. In other words, the illumination device 200c is formed by the plug portions 104a of the first connectors 104 connecting to the socket portions 106a of the second connectors 106.

Furthermore, the LED modules 100 can share a power supply (not shown), wherein the number of the LED modules 100 assembled depends on the power watts provided by the power supply. That is, the higher watt provided by the power supply, the greater the number of LED modules 100 can be connected together. Consequently, the illumination device 200c is formed by the LED modules 100 that are connected in serial or parallel.

Besides, in other embodiments, the LED modules 100 can be connected in serial or parallel to form illumination devices of other formats, such as 200d, 200e, and 200f, as shown in FIG. 2D, FIG. 2E, and FIG. 2F. Herein, the major difference among the illumination devices 200d, 200e, and 200f is that the illumination device 200d comprises with five LED modules 100, the illumination device 200e comprises with three LED modules 100, and the illumination device 200f comprises with four LED modules 100. The illumination devices 200d, 200e, and 200f assembled by the LED modules 100 are connected in serial or parallel to obtain different geometric figures, and the illumination distributions of illumination devices 200d, 200e, and 200f are all different.

It should be noted that the present invention is not limited to the combination pattern of the illumination devices 200a to 200f. Although the illumination devices 200a and 200b mentioned in FIG. 2A and FIG. 2B are assembled by the plurality of LED modules 100 that are connected in serial, the illumination devices 200c to 200f referred to in FIG. 2C to FIG. 2F are assembled by the plurality of LED modules 100 that are connected in serial or parallel. However, in other embodiments (not shown), the geometrical illumination devices 200a to 200f merely formed by the plug portions 104a of the first connectors 104 connecting to the socket portions 106a of the second connectors 106 would still be a part of the technical proposal of the present invention and not departing from the scope of protection sought by the present invention.

In short, the LED module 100 of the present embodiment can assemble the LED modules 100 into the geometrical illumination devices 200a to 200f by the plug portions 104a of the first connectors 104 connecting to the socket portions 106a of the second connectors 106. As a consequence, the application scope of the LED modules 100 is extended. Moreover, as the connectors 101 are assembled to each other to compose the LED modules 100 in the present embodiment, the assembly would be convenient for the user, and when the LED modules 100 malfunction or require maintenance, the user can easily detach the LED modules to perform maintenance or replacement.

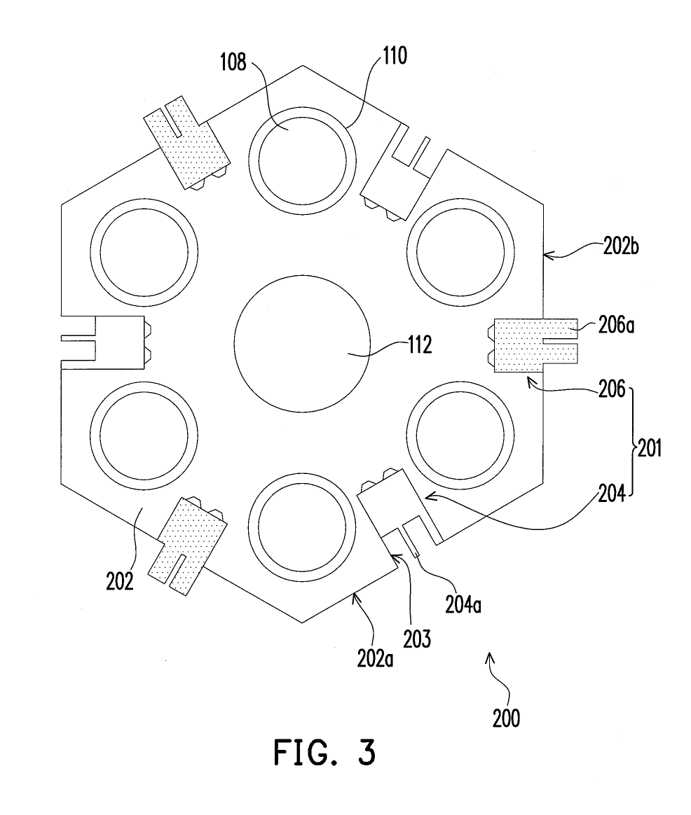

FIG. 3 is a schematic top view of an LED module in another embodiment of the present invention. It should be noted that some components are omitted in FIG. 3 to simplify the description. Referring to FIG. 3, in the present embodiment, an LED module 200 in FIG. 3 is similar to the LED module 100 in FIG. 1A. The main difference between the LED module 200 and the LED module 100 is that a connector 201 disposed on a carrier 202.

More particularly, in the present embodiment, the carrier 202 has a plurality of first edges 202a and a plurality of second edges 202b, and each of the first edges 202a includes a notch 203. The connector 201 includes a plurality of first connectors 204 (in FIG. 3, only three first connectors are exemplarily shown) and a plurality of second connectors 206 (in FIG. 3, only three second connectors are exemplarily shown). Here, the first connectors 204 are disposed on the first edges 202a of the carrier 202 respectively and electrically connected to the carrier 202. The second connectors 206 are disposed on the second edges 202b of the carrier 202 respectively and electrically connected to the carrier 202.

In detail, each of the first connectors 204 disposed on the first edge 202a has a plurality of first leads 204a. Additionally, the first pins 204a are disposed within the notches 203, and the first pins 204a are aligned with the first edges 202a. In other words, the first connectors 204 are female plugs as a matter of fact. Each of the second connectors 206 disposed on the second edge 202b of the carrier 202 includes a plurality of second pins 206a. Moreover, the second pins 206a protrude from the second edges 202b. In other words, the second connectors 206 are male plugs as a matter of fact. Especially, in the present embodiment, the second connectors 206 and the first connectors 204 are alternately arranged.

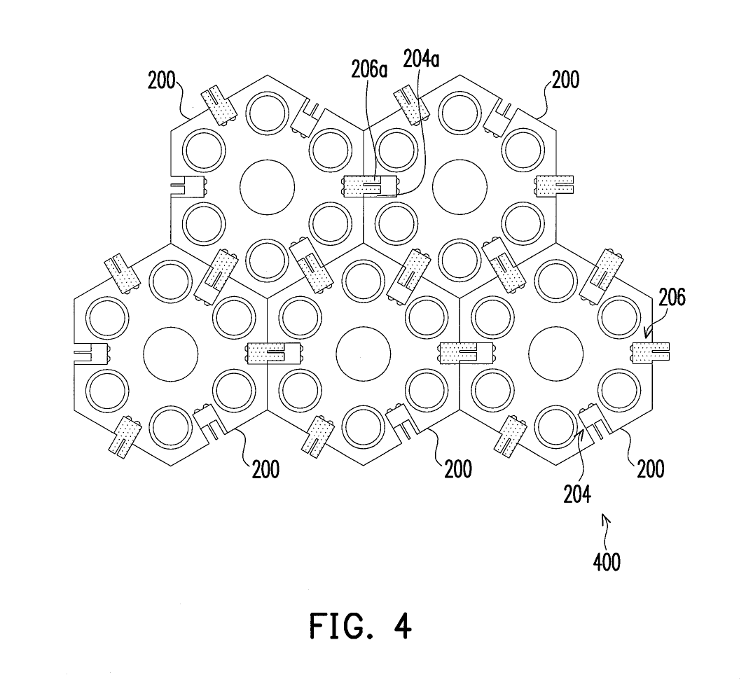

In the present embodiment, as the second connectors 206 and the first connectors 204 are alternately arranged, when a plurality of LED modules 200 is assembled into linear or planar illumination devices, the second pins 206a of the second connectors 206 of a single LED module 200 connect in serial or parallel to the first pins 204a of the first connectors 204 of a plurality of LED modules 200 so as to form linear (not shown) or planar illumination devices (referring to FIG. 4). Herein, the geometrical pattern formed can be similar to those in FIG. 2A to FIG. 2F, but is not limited thereto.

In short, since the second connectors 206 and the first connectors 204 of the LED modules 200 in the present embodiment are alternately arranged, when the plurality of LED modules 200 is assembled into a plurality of diverse illumination devices by serial or parallel connection, it is assured that each of the LED modules 200 is tightly connected to each other. Hence, the brightness and the illumination uniformity of the illumination devices assembled by the LED modules 200 are increase.

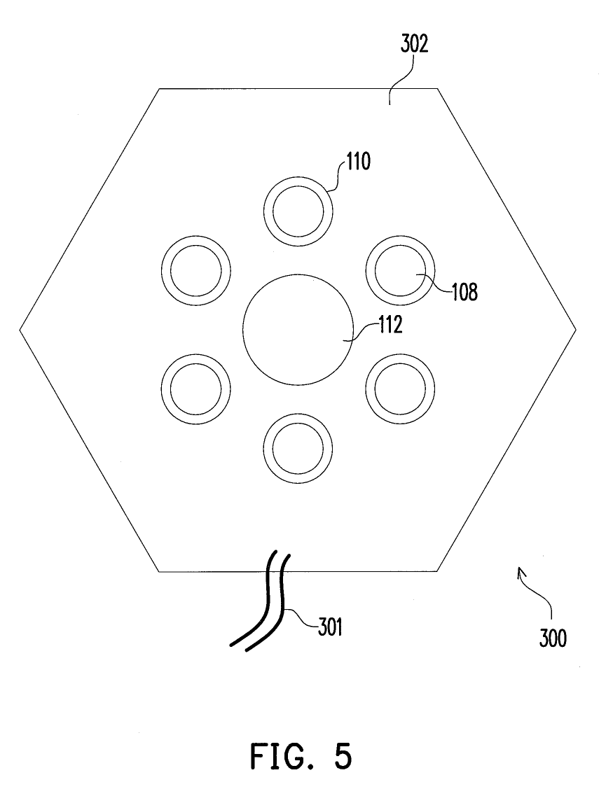

FIG. 5 is a schematic top view of an LED module in another embodiment of the present invention. Referring to FIG. 5, an LED module 300 in FIG. 5 is similar to the LED module 100 in FIG. 1A. The main difference between the LED module 300 and the LED module 100 is that the LED module 300 in FIG. 5 has at least a connecting wire 301. In addition, an end of the connecting wire 301 is disposed on a carrier 302 to replace the connecting function of the connector 101 in FIG. 1A. As a result, the connecting wire 301 can be used to connect a plurality of LED modules 300 in serial or parallel to assemble an illumination device. Here, the geometrical patterns formed can be the same as those in FIG. 2A to FIG. 2F, but are not limited thereto.

In light of the foregoing, as the LED module of the present invention includes at least one connector with pluggable function, the user may assemble a plurality of diverse geometrical illumination devices as required with the plurality of LED modules by the plug portion of one of the connectors connecting to the socket portion of one of the connectors of the other LED module. Therefore, the design of the LED module of the present invention not only extends the application scope of the LED module, but also brings convenience to the user to perform maintenance or replacement.

Although the present invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A light emitting diode (LED) module, comprising:
a carrier, having a first edge and a plurality of second edges;
a first connector, disposed on the first edge of the carrier and electrically connected to the carrier;
a plurality of second connectors, disposed on the second edges of the carrier and electrically connected to the carrier respectively, wherein each of the second connectors is corresponding and electrically connected to the first connector of the other LED module; and
a plurality of LEDs, disposed on and electrically connected to the carrier.

2. The LED module as claimed in claim 1, wherein a shape of the carrier comprises a hexagon, and the LEDs are arranged to the hexagon.

3. The LED module as claimed in claim 1, wherein the first connector has a plug portion protruding from the first edge, and each of the second connectors has a socket portion and the edges of the socket portions substantially align with the second edges.

4. The LED module as claimed in claim 1, further comprising a magnetic element disposed on the carrier so that the carrier having magnetism.

5. The LED module as claimed in claim 1, further comprising a plurality of lenses disposed on the carrier and covering the LEDs respectively.

6. The LED module as claimed in claim 5, wherein the lenses are disposed on the carrier by adhering, screwing, or locking.

7. A light emitting diode (LED) module, comprising:
a carrier, having a plurality of first edges and a plurality of second edges;
a plurality of first connectors, disposed on the first edges of the carrier and electrically connected to the carrier respectively;
a plurality of second connectors, disposed on the second edges of the carrier and electrically connected to the carrier respectively, wherein each of the second connectors is corresponding and electrically connected to the first connector of the other LED module; and
a plurality of LEDs, disposed on and electrically connected to the carrier.

8. The LED module as claimed in claim 7, wherein each of the first edges has a notch, each of the first connectors has a plurality of first pins located within the notch and aligned with the first edge, and each of the second connectors has a plurality of second pins protruding from the second edge.

9. The LED module as claimed in claim 7, wherein the second connectors and the first connectors are alternately arranged.

10. The LED module as claimed in claim 7, wherein a shape of the carrier comprises a hexagon, and the LEDs are arranged to the hexagon.

11. The LED module as claimed in claim 7, further comprising a magnetic element disposed on the carrier so that the carrier having magnetism.

12. The LED module as claimed in claim 7, wherein the LEDs are respectively located in the corners formed by each of adjacent two of the first edges and second edges.

13. The LED module as claimed in claim 7, further comprising a plurality of lenses disposed on the carrier and covering the LEDs respectively.

14. A light emitting diode (LED) module, comprising:
a carrier;
a plurality of LEDs, disposed on and electrically connected to the carrier; and
at least one connecting wire, disposed on and electrically connected to the carrier.

15. The LED module as claimed in claim 14, wherein a shape of the carrier comprises a hexagon, and the LEDs are arranged to the hexagon.

16. The LED module as claimed in claim 14, further comprising a magnetic element disposed on the carrier so that the carrier with magnetism.

17. The LED module as claimed in claim 14, further comprising a plurality of lenses disposed on the carrier and covering the LEDs respectively.

18. An illumination device, comprising:
a plurality of LED modules, selected from the LED modules of claim 7, wherein the LED modules are electrically connected to other LED modules by the first connector or the second connector of one LED modules electrically connecting with the first connector or the second connector of the other LED module.

19. The illumination device as claimed in claim 18, further comprising a magnetic element disposed on the carrier to provide the carrier with magnetism.

20. The illumination device as claimed in claim 18, further comprising a plurality of lenses disposed on the carrier and covering the LEDs respectively.
